(19) United States
(12) Patent Application Publication
(10) Pub. No.: US 2012/0293431 A1
(43) Pub. Date: Nov. 22, 2012

(54) SWITCHING DEVICE FOR A MACHINE, INSTALLATION, AND/OR TRANSPORT SYSTEM

(75) Inventor: Ronald Hauf, Mohrendorf (DE)

(73) Assignee: Siemens Aktiengesellschaft, Munchen (DE)

(21) Appl. No.: 13/473,199

(22) Filed: May 16, 2012

(30) Foreign Application Priority Data
May 17, 2011 (EP) EP11166352

(51) Int. Cl. G06F 3/041

(52) U.S. Cl. 345/173

(57) ABSTRACT

A switching device for a machine, installation, and/or transportation system has a touch-screen and at least one sensor element that is contained in the touch-screen and by means of which touching of the touch-screen can be registered and a corresponding signal fed out, with its being possible to effect emergency shutdown of the machine, installation, and/or transportation system by means of the switching device as a function of the at least one sensor element's signal. A method for operating a machine, installation, and/or transportation system includes the steps of touching a touch-screen, wherein the touch-screen includes at least one sensor element adapted to register said touching and to feed out a signal in response to the touching, and performing an emergency stopping and/or emergency shutdown of the machine, installation, and/or transportation system with a switching device as a function of the signal.

### CROSS-REFERENCES TO RELATED APPLICATIONS

This application claims the priority of German Patent Application, Serial No. EP11166352, filed May 17, 2011, pursuant to 35 U.S.C. 119(a)-(d), the disclosure of which is incorporated herein by reference.

### BACKGROUND OF THE INVENTION

The present invention relates to a switching device for a machine, installation, and/or transportation system, or also for use in safety control consoles in power stations. The present invention relates further to a method for operating a machine, installation, and/or transportation system.

The following discussion of related art is provided to assist the reader in understanding the advantages of the invention, and is not to be construed as an admission that this related art is prior art to this invention.

Touch-screens are being used increasingly in a variety of devices and for different application& Touch-screens of such kind have a touch-sensitive display element, with corresponding sensor elements registering touching of the display element for example by an operator's finger or fingers (multi-touch) or with the aid of a suitable pointer. The touch-screens are used inter alia for information monitors and vending/dispensing machines and in particular for smartphones.

Touch-screens can be used also for controlling machines and installations employed in industry. Touch-screens are increasingly being used instead of classical keyboards on control devices that include, for example, control panels, or handhelds that are used for controlling machines, installations, or transportation systems. The closed control panels of touch-screens where the cover or, as the case may be, support surface is made of, for example, glass are very robust and belong to a high protection class (at least IP65). The use of touch-screens eliminates the need for mechanical control elements and components—such as, for instance, buttons, switches, or plugs—and mechanical wear-and-tear and soiling cease to be causes of faults.

It would be desirable and advantageous to provide an improved switching device to obviate prior art shortcomings and to enable machines, installations, and/or transportation systems to be operated particularly safely via touch-screens.

### SUMMARY OF THE INVENTION

According to one aspect of the present invention, a switching device for a machine, installation, and/or transportation system can include: a touch-screen and at least one sensor element contained in the touch-screen and constructed to generate a signal in response to a touching of the touch-screen and to cause an emergency stopping and/or emergency shutdown of the machine, installation, and/or transportation system in response to the signal generated by the at least one sensor element.

To ensure clarity, it is necessary to establish the definition of several important terms and expressions that will be used throughout this disclosure. The term “emergency shutdown” relates to are all functions that can be performed as a consequence of actuating a known emergency stop button. They include “stopping in an emergency” or, as the case may be, emergency stopping and “switching off in an emergency”. Emergency shutdown is designed to be self-retaining and can only be rescinded by performing appropriate operating steps.

The term “emergency stop button” is used in the following for the terms “emergency stop button”, “emergency off button”, and “emergency stop switch”.

The present invention is based on the notion that when a machine, installation, or transportation system is made to undergo an emergency shutdown, that is at present still done exclusively by way of a mechanical command trigger, namely the red/yellow emergency stop button. The emergency stop button is an integral constituent of control components or is attached as a separate unit. Since the mid '90s it has also been possible to employ electronic components and software in the safety system if they are suitably embodied. The signals from emergency stop buttons are already transmitted and evaluated predominantly electronically.

A switching device is inventively provided that has a touch-screen or, as the case may be, display element. The operation of a machine, installation, and/or transportation system can thus be controlled by means of the touch-screen, but it is also possible to display relevant data for example about the machine's, installation's, and/or transportation system's current operating condition. All the functions of the known emergency stop button should moreover be enabled by means of the switching device having the display element or, as the case may be, touch-screen. The switching device can contain the hardware components and/or software programs necessary therefore to enable an emergency shutdown. Said components can also be located outside the switching device. The variety of hardware can here be kept to a minimum and relevant customer differentiating can be purely software-based. The switching device's use can furthermore reduce the number of interfaces. The aim is for emergency shutdown to meet current standards through its safe implementation. No losses or, as the case may be, disadvantages whatsoever will hence be incurred compared with the known emergency stop button.

The entire area of the touch-screen or, as the case may be, display element will in this case serve as a triggering area through activating which the machine, installation, and/or transportation system can be made to undergo an emergency shutdown. For that purpose at least one sensor element is provided that is coupled to the touch-screen and by means of which an operator's touching of the touch-screen can be registered. An operator's touching of the touch-screen can hence serve to operate or, as the case may be, control the machine, installation, or transportation system and furthermore to make it undergo an emergency shutdown. Operation and effecting emergency shutdown are performed preferably by the operator's touching the touch-screen with one or more fingers or, as the case may be, pressing on the touch-screen with his/her fingers. Emergency stopping or, as the case may be, emergency shutdown of the machine, installation, and/or transportation system can be effected by means of the switching device as a function of a signal of the at least one sensor element.

The integrated emergency-stop function is indicated on the touch-screen's or, as the case may be, display element's surface by means of appropriate identification, for example a yellow/red/yellow frame. Identification can be by way of a pure color marking or in the form of a screen display or, as the case may be, light-emitting diodes (LEDs). A significantly larger actuating area than hitherto is provided by the switching device's touch-screen for triggering an emergency shutdown and the operator can moreover react faster because he/she will already be touching the display element or, as the case may be, touch-screen while operating the machine, installation, and/or transportation system.

The switching device can be used, for example, for controlling electric machines and installations, for chemical plants and power stations, in hygienic areas in hospitals or in technical medical equipment, in the food and luxury comestibles industry, or in the control consoles of transportation means (trains or ships, for instance) and systems.

The switching device will make it possible to simplify the infrastructure for the aforementioned applications or, as the case may be, deployment sectors as well as increasing availability and safety.

According to another advantageous feature of the invention, the at least one sensor element causes the emergency stopping and/or emergency shutdown, when the signal exceeds a predefined threshold value and/or as a function of a course over time of the signal. The at least one sensor element registers an operator's touching of the touch-screen and feeds out a corresponding signal as a function thereof. The machine, installation, and/or transportation system will be made to undergo an emergency shutdown if said signal exceeds a predefined threshold. Another possibility is to check the course over time of the at least one sensor element's signal and to perform an emergency shutdown as a function of, for example, the slew rate of the sensor element's signal. By specifying a threshold or examining the signal's course over time it is possible to clearly distinguish between normal operation and the operator's intention to subject the machine, installation, and/or transportation system to an emergency shutdown.

According to another advantageous feature of the invention, the at least one sensor element can be adapted to register an amplitude and/or a course over time of a pressure exerted on the touch-screen, with the signal being generated by the at least one sensor element being commensurate with the amplitude and/or course over time of the pressure. An operator in the process of operating the machine, installation, and/or transportation system by means of the touch-screen can in a danger situation exert increased pressure on the touch-screen and thereby effect an emergency shutdown. The pressure's course over time can also be examined on the touch-screen.

That has the advantage that in order to effect an emergency shutdown the operator's finger(s) will not have to be lifted from the touch-screen while the machine, installation, and/or transportation system is being operated. Triggering the emergency shutdown will be intuitive for the operator since it corresponds to the known, firm pressure exerted on the emergency stop button. An emergency shutdown can here be effected through the operator's exerting firm or, as the case may be, increased pressure on the touch-screen. Safety can be enhanced thereby because a much faster reaction will then be possible that is direct and reflexive.

According to another advantageous feature of the invention, the at least one sensor element can be adapted to register an amplitude and/or a course over time of an acceleration in the touching of the touch-screen, with the signal being generated by the at least one sensor element being commensurate with the amplitude and/or course over time of the acceleration. Instead of the pressure exerted on the touch-screen, the acceleration in the touching of the touch-screen can likewise be evaluated. That is potentially applicable when, for example, the operator is in the vicinity of the switching device and not actively operating the machine, installation, and/or transportation system by means of the switching device. Account is taken therein of the knowledge that the emergency stop buttons are not as a rule pressed but instead struck.

According to another advantageous feature of the invention, the switching device can include two of the sensor element to cause the emergency stopping and/or emergency shutdown of the machine, installation, and/or transportation system, when the signal generated by each of the two sensor elements meets the predefined criterion. It is expedient to embody the touch-screen's or, as the case may be, display element's sensor elements as being diversified and redundant to prevent an emergency shutdown of the machine, installation, and/or transportation system from being triggered erroneously. Erroneous triggering caused by, for example, the impact of sunlight or liquids on the touch-screen can be prevented in that way. Safety and reliability in controlling and operating machines, installations, or transportation systems will be enhanced thereby.

According to another advantageous feature of the invention, the emergency stopping and/or emergency shutdown may only be performed when the signals of the two sensor elements occur simultaneously. Erroneous triggering of an emergency shutdown of the machine, installation, and/or transportation system can be particularly effectively prevented in that way. It is also conceivable for the two sensor elements' signals to have to be activated spaced a predefined time apart to achieve an emergency shutdown. The use of two sensor elements is suitable in the case of power stations, for example, because incorrect operation has to be avoided here.

According to another advantageous feature of the invention, the two sensor elements can be adapted for registering same measured variables. Touching of the display element or, as the case may be, touch-screen can be ascertained using known sensor principles. Said touching can be registered, for example, by capacitive, resistive, optical, or inductive means, using ultrasound (Surface Acoustic Wave) or Dispersive Signal Technology (DST), or piezoelectrically. Depending on the specific concept it can be necessary to employ a plurality of sensor elements for the emergency shutdown. It is also conceivable to use two sensor elements based on different sensor principles.

According to another advantageous feature of the invention wherein the at least one sensor element can be adapted to cause an emergency switch-off, thereby electrically isolating the machine, installation, and/or transportation system from a power supply. A person can thereby be prevented from being injured by an electrical accident or, as the case may be, an electric shock.

In another advantageous embodiment, an emergency shutdown can be communicated to an operator by means of the switching device. When an emergency shutdown of the machine, installation, and/or transportation system has been triggered, that will be indicated optically or acoustically, for instance. For example a corresponding warning signal can be fed out for that purpose. Triggering of an emergency shutdown is indicated preferably optically, for example by the flashing of a surrounding color frame or as a display on the touch-screen. A corresponding text or a symbol—for example an image of the emergency stop button—can also be shown on the touch-screen.

The optical indication will also make it possible to differentiate between different operating conditions. Hence as an ancillary effect it will for the first time be possible to identify inactive control elements for which the emergency-stop function is no longer effective. A still prevailing problem would be solved thereby. That also applies in a comparable manner to machines that have been totally shut down.

According to another aspect of the present invention, a method for operating a machine, installation, and/or transportation system can include the steps of generating a signal by at least one sensor element in response to a touching of a touch-screen, and executing an emergency stopping and/or emergency shutdown of the machine, installation, and/or transportation system in response to the signal generated by the at least one sensor element.

The developments described with reference to the inventive switching device can be applied analogously to the inventive method.

### BRIEF DESCRIPTION OF THE DRAWING

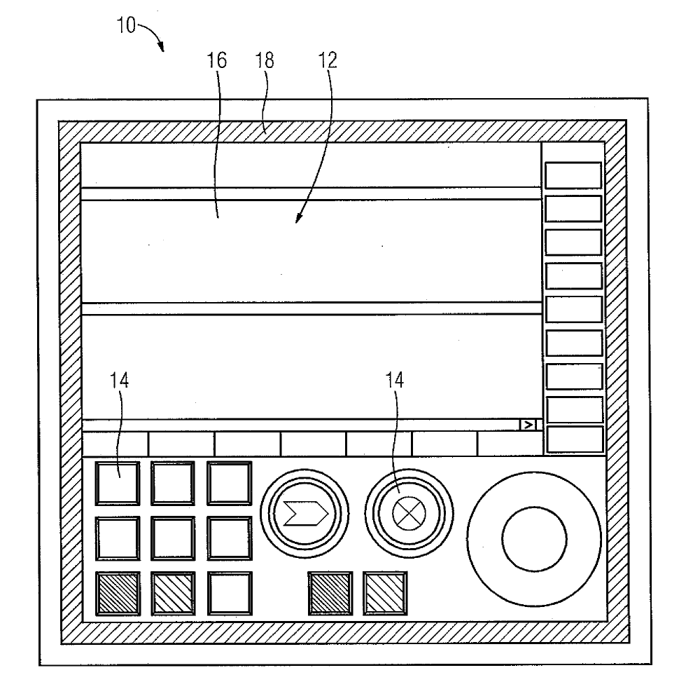

Other features and advantages of the present invention will be more readily apparent upon reading the following description of currently preferred exemplified embodiments of the invention with reference to the accompanying drawing, in which the sole FIG. 1 shows a schematic illustration of a switching device for a machine, installation, and/or transportation system.

### DETAILED DESCRIPTION OF PREFERRED EMBODIMENTS

The depicted embodiment is to be understood as illustrative of the invention and not as limiting in any way. It should also be understood that the drawing is not necessarily to scale and that embodiments are sometimes illustrated by graphic symbols, phantom lines, diagrammatic representations and fragmentary views. In certain instances, details which are not necessary for an understanding of the present invention or which render other details difficult to perceive may have been omitted.

Turning now to FIG. 1, there is shown a schematic illustration of a switching device, generally designated by reference numeral 10 for use in a machine, installation, and/or transportation system. The switching device 10 includes a touch-screen 12 or, as the case may be, display element, with at least one sensor element (not shown here) being coupled to touch-screen 12. The sensor element can, for example, also be integrated in the support surface of touch-screen 12. Touching of touch-screen 12 can be registered by means of the at least one sensor element. A machine, installation, or transportation system can be controlled or, as the case may be, operated, or appropriate functions thereof be selected by touching of touch-screen 12.

Shown on display element 12 are for that purpose a plurality of control areas 14 which can represent a key, for instance. Current information or, as the case may be, functions of the machine, installation, and/or transportation system that are controlled with the aid of switching device 10 are shown on a corresponding display area 16 of touch-screen 12.

The position, arrangement, and size of control areas 14 and display areas 16 can be freely selected or, as the case may be, configured. The Figure shows an exemplary embodiment.

Switching device 10 thus makes all functions possible for controlling and operating machines, installations, or transportation systems and should furthermore include all functions of the known emergency stop button. The hardware components or, as the case may be, electronic components necessary for effecting an emergency shutdown and the software programs can be integrated in switching device 10. It is also conceivable for said components to be located outside switching device 10. A suitable evaluation logic for evaluating the sensor signals can for that purpose be provided in switching device 10.

The machine, installation, and/or transportation system can undergo an emergency shutdown effected by means of switching device 10 as a function of a signal of the at least one sensor element. Instead of the known emergency stop button, what is in this case used is the total area of touch-screen 12 of switching device 10 which is actuated to achieve an emergency shutdown of the machine, installation, and/or transportation system. Emergency shutdown is performed as a function of the exceeding of a threshold and/or a course over time of the at least one sensor element's signal.

There is a possibility for an amplitude and/or a course over time of a pressure being exerted on touch-screen 12 to be registered by means of the at least one sensor element and a corresponding value to be fed out in the signal. An emergency shutdown can hence be performed on the machine, installation, and/or transportation system through the operator's exerting increased pressure on touch-screen 12. The known sensors usually employed for touch-screens can be used as sensor elements. Touching of touch-screen 12 can be registered, for example, by capacitive, resistive, optical, or inductive means, using ultrasound (Surface Acoustic Wave) or Dispersive Signal Technology (DST), or piezoelectrically.

It is also possible for an amplitude and/or a course over time of an acceleration in the touching of touch-screen 12 to be registered by means of the at least one sensor element. It is hence possible to effect an emergency shutdown of the machine, installation, and/or transportation system through an operator's correspondingly striking touch-screen 12.

Hence the entire area of touch-screen 12 can be used for effecting an emergency shutdown. Appropriate identification is provided on the switching device to draw attention to the emergency-stop function of switching device 10. Said identification is indicated schematically in the Figure by region 18 having a dashed outline. Said region 18 has been applied to switching device 10 as a yellow/red/yellow marking, for example. Corresponding colored light-emitting diodes (LEDs) or suchlike can for that purpose also be located on switching device 10. It is also conceivable to show the marking or, as the case may be, identification on touch-screen 12 preferably by means of a surrounding yellow/red/yellow frame.

After an emergency shutdown of the machine, installation, and/or transportation system has been triggered, that can be shown in region 18 or on touch-screen 12. For example a text message or an image of an emergency stop button can for that purpose be shown on touch-screen 12.

Emergency shutdown can also be rescinded by operating touch-screen 12. Two control areas 14, for example, can be actuated for that purpose. Said control areas 14 can be arranged, for example, in such a way that they can only be operated with two hands.

The switching device 10 is to be produced in conformity with existing safety standards. The control panel of touch-screen 12, which panel is made of glass, for example, should belong to a high protection class (at least IP65).

The switching device 10 shown in FIG. 1 can be used for different types of operating panels, machine control panels, handhelds, or the like. The switching device 10 can hereby have all manner of geometries exhibiting round or rectangular basic shapes.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A switching device for a machine, installation, and/or transportation system comprising:
a touch-screen; and
at least one sensor element contained in the touch-screen and constructed to generate a signal in response to a touching of the touch-screen and to cause an emergency stopping and/or emergency shutdown of the machine, installation, and/or transportation system in response to the signal generated by the at least one sensor element.

2. The switching device of claim 1, wherein the at least one sensor element causes the emergency stopping and/or emergency shutdown, when the signal exceeds a predefined threshold value and/or as a function of a course over time of the signal.

3. The switching device of claim 1, wherein the at least one sensor element is adapted to register an amplitude and/or a course over time of a pressure exerted on the touch-screen, with the signal being generated by the at least one sensor element being commensurate with the amplitude and/or course over time of the pressure.

4. The switching device of claim 1, wherein the at least one sensor element is adapted to register an amplitude and/or a course over time of an acceleration in the touching of the touch-screen, with the signal being generated by the at least one sensor element being commensurate with the amplitude and/or course over time of the acceleration.

5. The switching device of claim 1, further comprising two of said sensor element to cause the emergency stopping and/or emergency shutdown of the machine, installation, and/or transportation system, when the signal generated by each of the two sensor elements meets the predefined criterion.

6. The switching device of claim 5, wherein the emergency stopping and/or emergency shutdown is only performed when the signals of the two sensor elements occur simultaneously.

7. The switching device of claim 5, wherein the two sensor elements are adapted for registering same measured variables.

8. The switching device of claim 1, wherein the at least one sensor element is adapted to cause an emergency switch-off, thereby electrically isolating the machine, installation, and/or transportation system from a power supply.

9. The switching device of claim 1, wherein the switching device is adapted to communicate the emergency stopping and/or emergency shutdown to an operator.

10. A method for operating a machine, installation, and/or transportation system comprising the steps of:
generating a signal by at least one sensor element in response to a touching of a touch-screen; and
executing an emergency stopping and/or emergency shutdown of the machine, installation, and/or transportation system in response to the signal generated by the at least one sensor element.
